(19) United States
(12) Patent Application Publication
(10) Pub. No.: US 2006/0098425 A1
(43) Pub. Date: May 11, 2006

(54) Advertising support with illuminated magnifier

(76) Inventor: William H. Waterhouse, Norman, OK (US)

Correspondence Address: JAMES T. ROBINSON, 222 E. MAIN STREET, NORMAN, OK, 73069, US

(21) Appl. No.: 11/133,947

(22) Filed: May 20, 2005

Related U.S. Application Data
(63) Continuation-in-part of application No. 10/982,964, filed on Nov. 5, 2004.

(51) Int. Cl. F21L 4/00; F21V 33/00

(52) U.S. Cl. 362/190; 362/191; 362/253; 362/812

(57) ABSTRACT

An illuminated magnifier base for supporting a table topper or other device provides a rectangular plate having a top, a bottom, two long edges, and two short edges; a first leg member having an upper portion, a lower portion, and a lower edge, wherein the upper portion of the leg member is attached to one of the long edges of the rectangular plate; a second leg member having an upper portion, a lower portion, and a lower edge, wherein the upper portion of the second leg member is attached to the other long edge of the rectangular plate; a magnifying member attached to one leg member; a lamp-battery assembly attached to the bottom of the rectangular plate; and a switch attached to a leg member for switching on the battery-powered lamp, wherein the switch is in serial connection with the lamp and the battery.

### BACKGROUND

This application is a continuation-in-part of application Ser. No. 10/982,964 filed Nov. 5, 2004. An illuminated magnifier base is provided for use in conjunction with a table-top advertising support. This invention provides a table-top advertising support which includes an illuminated magnifier. The invention is also referred to herein, from time to time, as a table topper.

### BACKGROUND OF THE INVENTION

### Discussion

Restaurants commonly use table-top advertising supports to provide information to diners. The information may relate to business hours, new dishes, or beverage promotions. Restaurants are often dimly lit, so diners may have difficulty reading either the menu or, more frequently, the sales slip (also referred to herein as the check) presented for payment following completion of a meal.

Applicant's improved advertising support with a diner-activated illuminated magnifier (table topper) is adapted for a low cost of manufacture, thereby facilitating a restaurant supplier's furnishing the advertising support with illuminated magnifier along with the supplier's advertising materials.

As used herein, the term “advertising” or “information” includes, without limitation, advertisements/pricing for food and beverages, emergency numbers, sayings, news of coming events/specials, or any other visual material.

### SUMMARY OF THE INVENTION

A table-top advertising support with illuminated magnifier includes a taller section containing a fresnel lens and a lamp-switch-battery assembly in a lower portion and an upper portion having vertically aligned elongated slots formed by cooperation of staggered opposing tabs. The taller section is attached to a shorter section containing a second fresnel lens disposed within a frame.

In another embodiment, an illuminated magnifier base is adapted to support existing table toppers and other devices. The illuminated magnifier base provides a generally rectangular plate supported by two leg members. A magnifier is attached to one of the leg members. A lamp-battery assembly is attached to the bottom of the rectangular plate, and a serial switch actuates the battery powered lamp.

### BRIEF DESCRIPTION OF THE DRAWINGS

FIG. 1 shows the advertising support with illuminated magnifier of the present invention wherein the two mating sections are assembled.

FIG. 2 is another view of the lower portion of the table topper shown in FIG. 1, wherein the two mating sections are exploded away from each other.

FIG. 3 is a view of the shorter of the two mating sections shown in FIG. 2.

FIG. 4 is a view of the taller of the two mating sections shown in FIG. 2.

FIG. 5 is another view of the table topper shown in FIG. 1.

FIG. 6 shows another advertising support with illuminated magnifier according to the present invention.

FIG. 7 is another view of the table topper shown in FIG. 6.

FIG. 8 is a bottom view of the table topper shown in FIG. 6.

FIG. 9 is a stylized schematic of the battery-switch-lamp of the present invention.

FIG. 10 is an enlarged cross-section, with a portion of the vertical advertising panel cut away, showing an alternate structure for the bottom portions of the two mating sections of the present invention.

FIG. 11 is an enlarged cross-section, with a portion of the vertical advertising panel cut away, showing still another alternate structure for the bottom portions of the two mating sections of the present invention.

FIG. 12 is an enlarged cross-section, with a portion of the vertical advertising panel cut away, showing still another alternate structure for the bottom portions of the two mating sections of the present invention.

FIG. 13 is an enlarged cross-section, with a portion of the vertical advertising panel cut away, showing the structure of the device shown in FIG. 12 combined with a switch for activated the battery-powered lamp.

FIG. 14 is an enlarged cross-section, with a portion of the vertical advertising panel cut away, showing another configuration of a switch deployed between the two mating sections.

FIG. 15 is an enlarged cross-section, with a portion of the vertical advertising panel cut away, showing still another configuration of a switch deployed between the two mating sections.

FIG. 16 is an enlarged cross-section, with a portion of the vertical advertising panel cut away, showing still another configuration of a switch deployed between the two mating sections.

FIG. 17 is an enlarged cross-section, with a portion of the vertical advertising panel cut away, showing still another configuration of a switch deployed between the two mating sections.

FIG. 18 shows another advertising support with illuminated magnifier according to the present invention.

FIG. 19 is another view of the table topper shown in FIG. 18, wherein the structural elements are exploded vertically for ease of viewing.

FIG. 20 shows another table topper according to applicant's invention, wherein two leg members form a base and one leg member receives a vertical display member.

FIG. 21 shows a prior art table topper.

FIG. 22 shows the prior art table topper shown in FIG. 21 attached to a base containing an illuminated magnifier according to applicant's invention.

FIG. 23 shows the table topper shown in FIG. 21 attached to another base containing an illuminated magnifier according to applicant's invention.

FIG. 23 shows the table topper shown in FIG. 21 attached to another base containing an illuminated magnifier according to applicant's invention.

FIG. 24 shows another base containing an illuminated magnifier according to applicant's invention.

FIG. 25 shows another base containing an illuminated magnifier according to applicant's invention attached to a prior art device by a double-sided adhesive strip.

FIG. 26 shows another base containing an illuminated magnifier according to applicant's invention attached to another device by screws.

FIG. 27 shows another base containing an illuminated magnifier according to applicant's invention attached to the prior art table topper shown in FIG. 21.

### DETAILED DESCRIPTION

In the following description of the of the present invention, like numerals and characters designate like elements throughout the figures of the drawings.

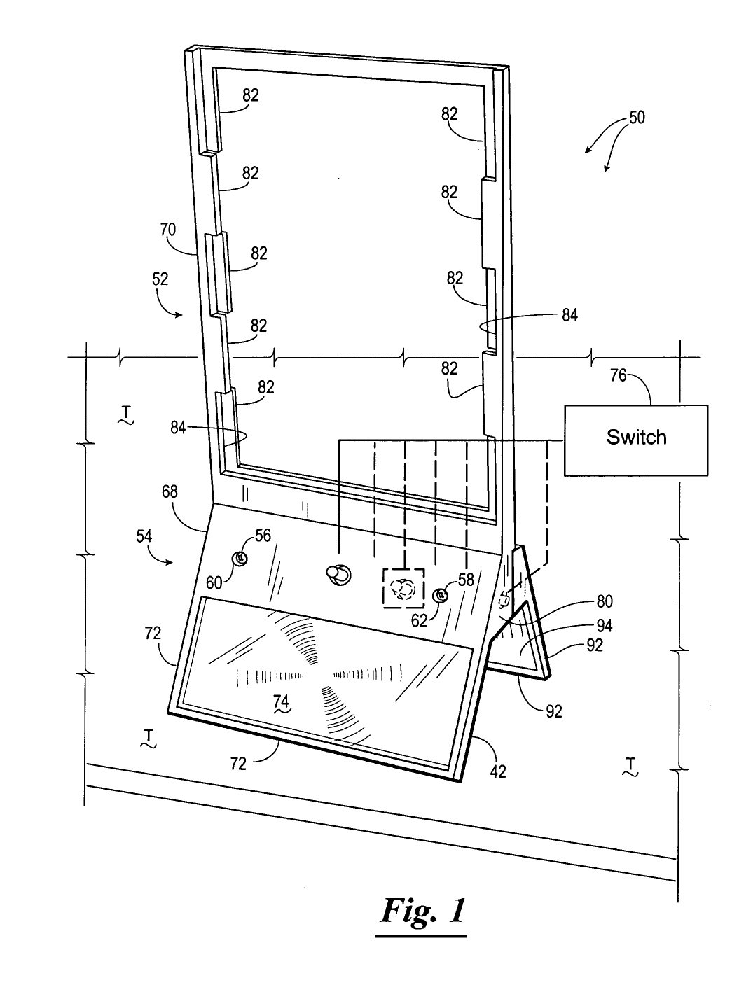

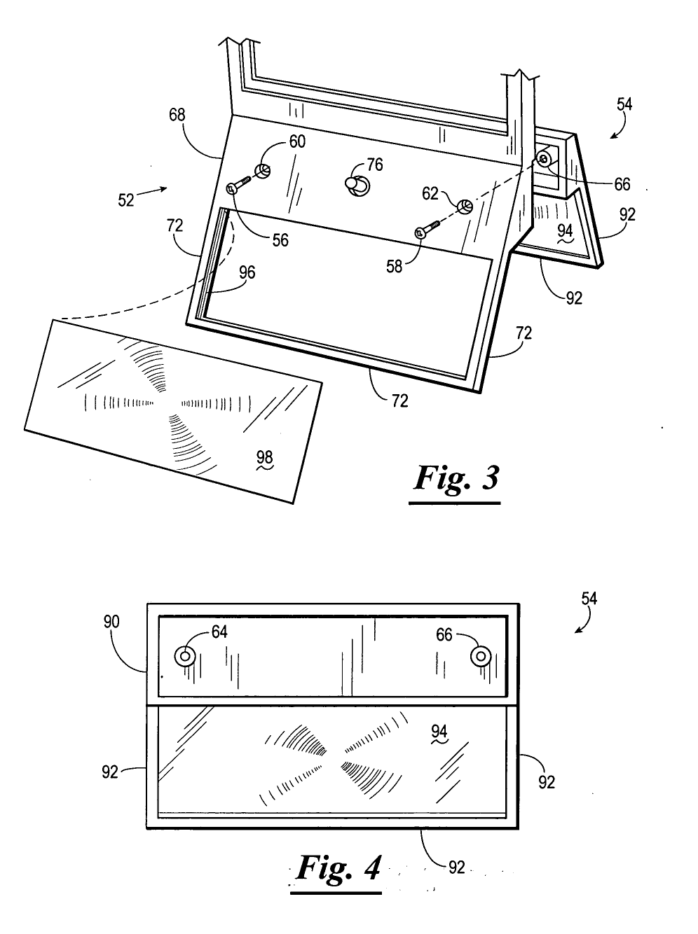

Referring generally to the drawings and more particularly to FIGS. 1-5, a table topper 50 includes a taller section 52 and a shorter section 54. As shown more clearly in FIGS. 3-4, screws 56, 58 disposed in bores 60, 62 in the taller section 52 engage receiving bores 64, 66 in the shorter section 54.

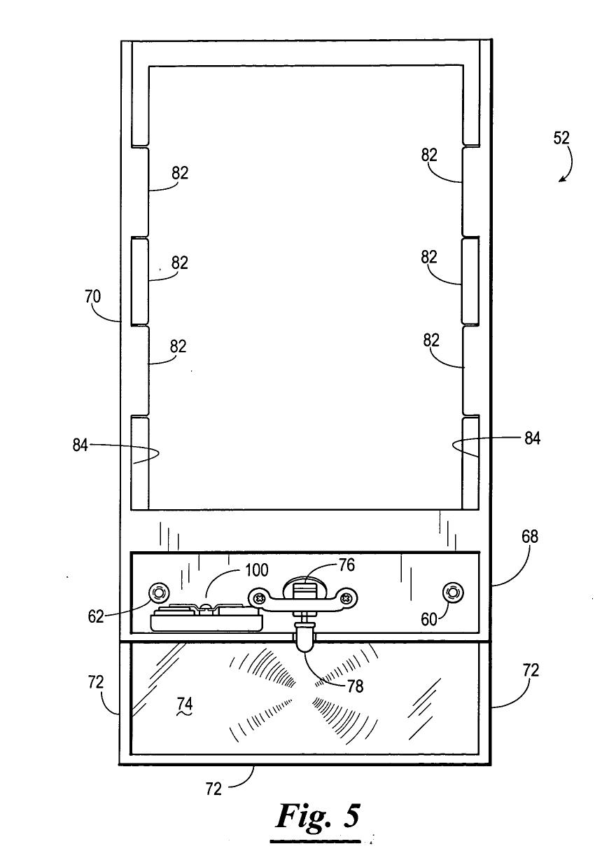

Referring now to FIG. 1, the taller section 52 includes a lower portion 68 and an upper portion 70. A frame 72 in the lower portion 68 houses an integrally molded fresnel lens 74. A switch 76 located above the frame 72 in the lower portion 68 actuates a lamp 78 (see FIG. 5). The lower portion 68 of the taller section 52 includes an end panel 80. As illustrated by the phantom lines and the phantom switches in FIG. 1, the switch 76 can be located at any convenient location.

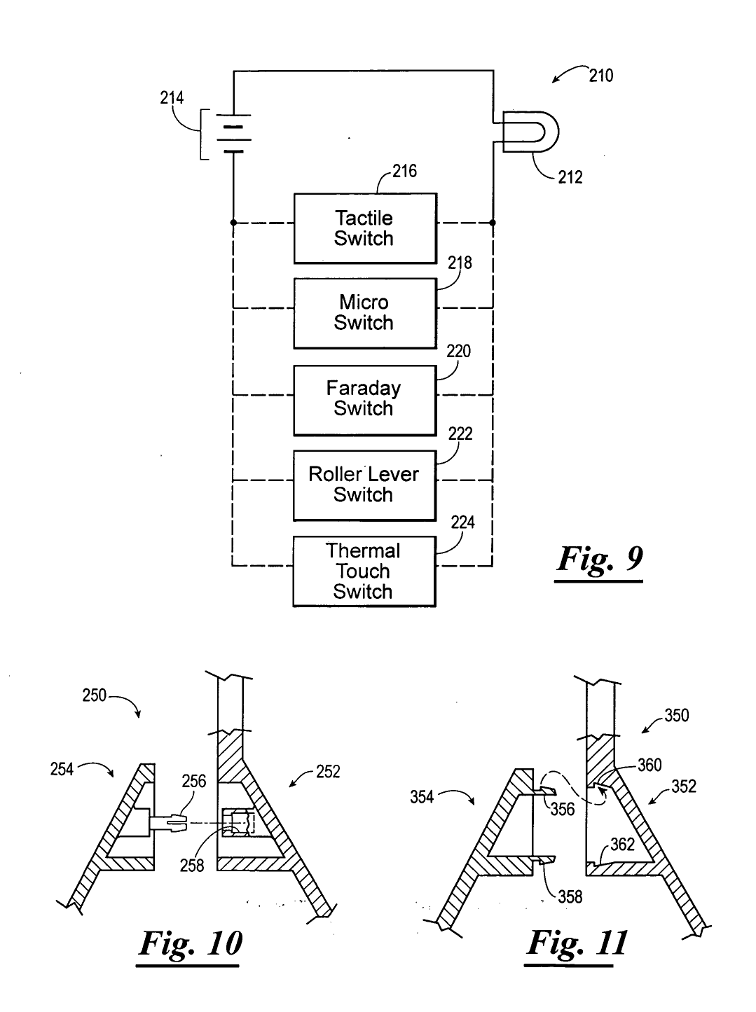

The switch shown in FIG. 1 is a common momentary micro switch. It will be understood by one skilled in the art that various types of switches can be utilized according to applicant's invention. Tactile switches, micro switches, Faraday switches, roller lever switches, and thermal touch switches (referred to herein, collectively, as touch switches) are known in the art and suitable for use in applicant's table topper 50 (see FIG. 9).

It will be further understood by one skilled in the art that, while the lamp 78 in FIG. 5 is a light emitting diode (LED), any convenient lamp can be used including, without limitation, incandescent bulbs and halogen lamps.

Referring now to FIGS. 1, 2, and 5, staggered opposing tabs 82 in the upper portion 70 of the taller section 52 cooperate to form a pair of vertically aligned elongated slots 84. The vertically aligned elongated slots 84 are adapted to receive advertising or other informational material to be displayed in the table topper 50.

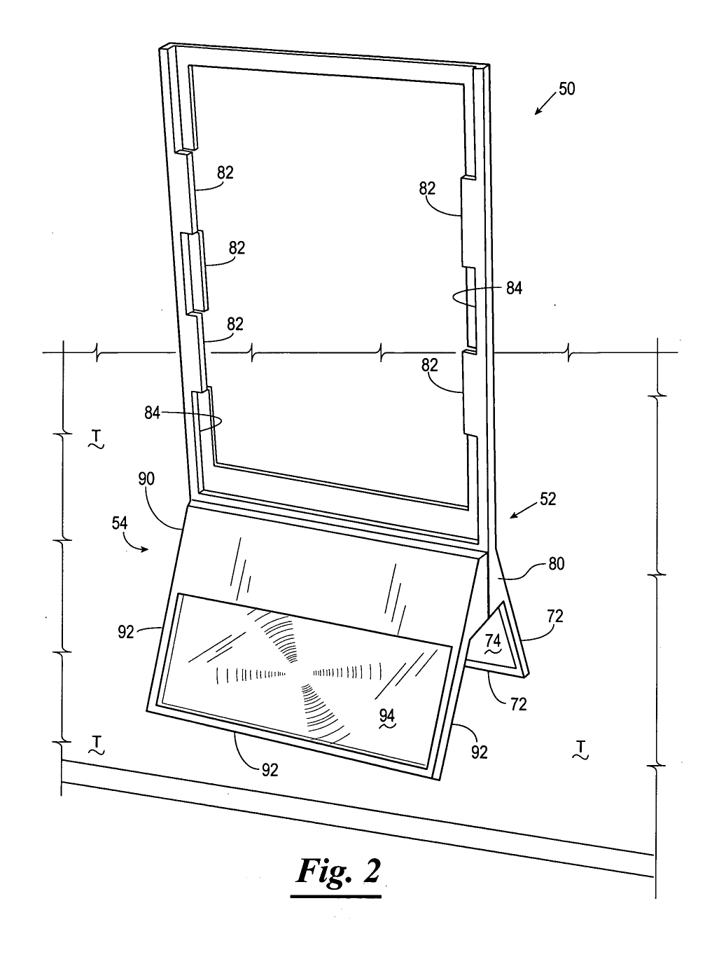

Referring now to FIGS. 1-2, the shorter section 54 includes an upper portion 90 and a frame 92 surrounding an integrally molded fresnel lens 94.

Referring now to FIG. 3, a ledge 96 in the frame 72 in the lower portion 68 of the taller section 52 receives a removable fresnel lens 98.

It will be understood by one skilled in the art that the fresnel lens 94 can be molded simultaneously with the frame 92 and the upper portion 90 of the shorter section 54. In the alternative, the upper portion 90 and the frame 92 can be molded in a single operation, followed by insertion of the removable fresnel lens 98 in the frame 92. Simultaneous molding of the fresnel lens together with the frame 92 and the upper portion 90 results in a significant cost reduction.

It will be further understood by one skilled in the art that the fresnel lens 74 can be molded in a single operation with the remainder of the taller section 52 or, in the alternative, a fresnel lens can be attached to the frame 72 in a second operation.

Referring now to FIG. 5, the switch 76 is viewed from the back side of the taller section 52. The lamp 78 is powered by a battery 100 when the lamp circuit is switched on.

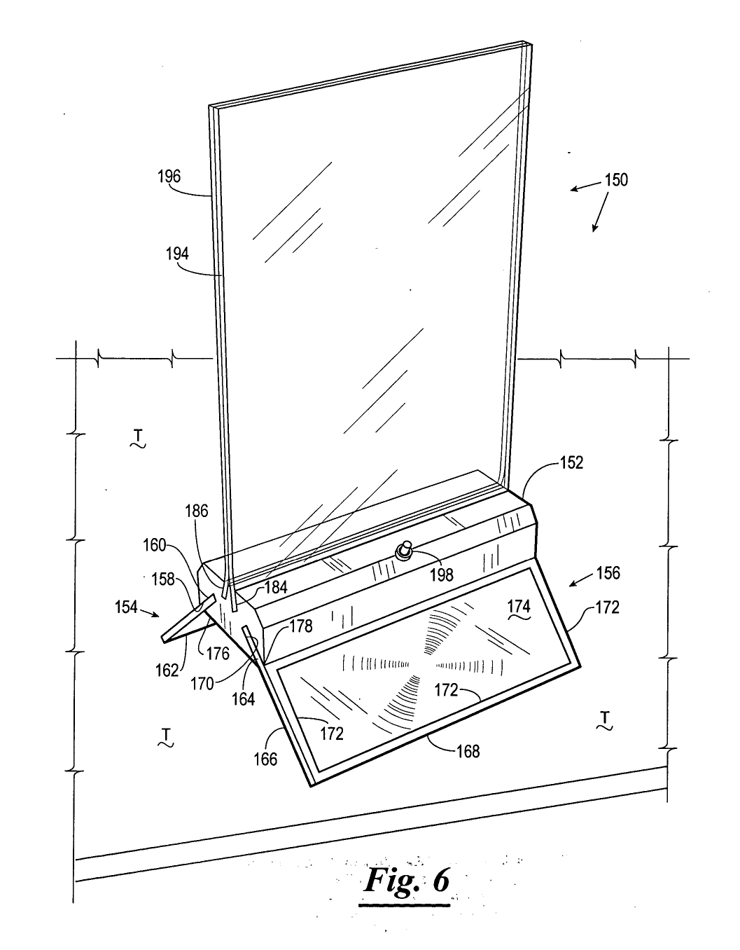

Referring now to FIGS. 6-8, another table topper 150 according to applicant's invention includes a junction block 152 supported by leg member 154 and magnifying leg member 156. The upper portion 158 of the leg member 154 is press fit into a slot 160 in the junction block 152, and the lower edge 162 of the leg member 154 rests on the table top T. The magnifying leg member 156 has an upper portion 164, a lower portion 166, and a lower edge 168. The upper portion 164 of the magnifying leg member 156 is press fit into a slot 170 in the junction block 152. The lower portion 166 of the magnifying leg member 156 includes a frame portion 172. A molded fresnel lens 174 is attached to the frame portion 172 of the magnifying leg member 156.

Still referring to FIGS. 6-8, the slots 160, 170 are cut at an angle in the outside bottom edge portions 176, 178, respectively of the junction block 152 so that the lower edges 162, 168 of the leg member 154 and the magnifying leg member 156, respectively, flare outwardly down and away from the junction block 152 to provide a stable base of support for the table topper 150.

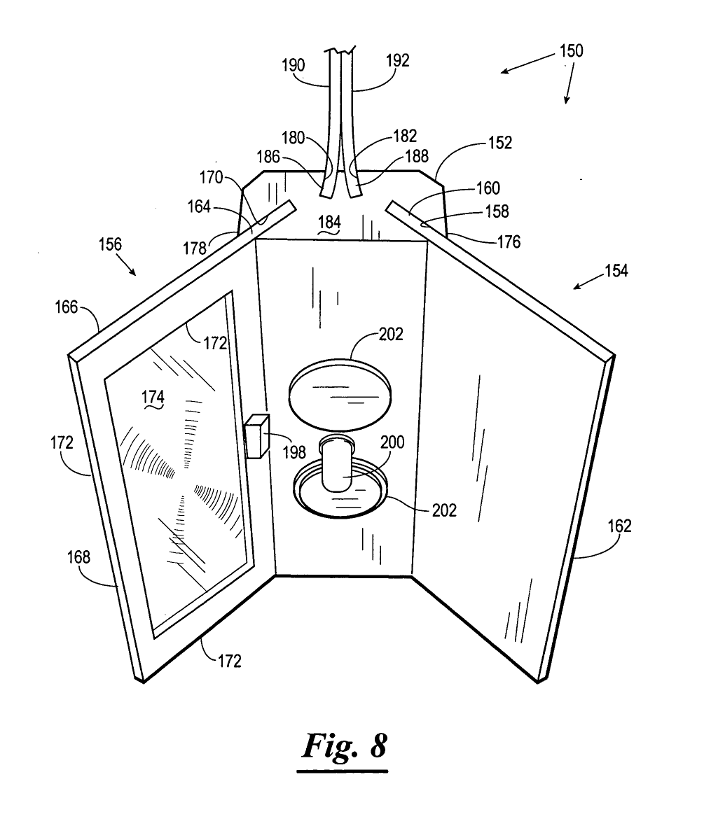

As best seen in FIG. 8, slots 180, 182 in the top center portion 184 of the junction block 152 receive the bottom portions 186, 188 respectively of vertical panes 190, 192. The bottom portions 186, 188 are frictionally biased within the slots 180, 182, respectively. The slots 180, 182 are angled upwardly toward each other so that, when inserted into the slots 180, 182, the upper portions 194, 196 of the vertical panes 190, 192 are pressed together so that a card or paper containing information (not shown) inserted between the vertical panes 190, 192 is held firmly in place.

Referring now to FIGS. 6 and 8, a switch 198 activates a lamp 200 powered by a batteries 202.

It will be understood by one skilled in the art that, while the junction block 152 shown in FIGS. 6-8 is depicted as a more-or-less rectangular cube, the junction block 152 can be spherical or any other particular shape permitting attachment of the leg member 154, the magnifying leg member 156, the vertical panes 194, 196, the switch 198, the lamp 200, and the batteries 202.

Referring now to FIG. 9, a circuit diagram 210 shows a lamp 212 powered by a battery 214 actuated by, in the alternative, a tactile switch 216, a micro switch 218, a Faraday switch 220, a roller lever switch 222, or a thermal touch switch 224. Each switch set forth herein is known in the art and, therefore, will not be discussed in detail. Any type of switch can be used in applicant's Advertising Support with Illuminated Magnifier.

Referring now to FIG. 10, another table topper 250 according to the present invention includes a taller section 252 and a shorter section 254. A split barbed projection 256 molded as part of the shorter section 254 mates with a shouldered receptacle 258 molded as part of the taller section 252 to secure the shorter section 254 to the taller section 252.

Referring now to FIG. 11, another table topper 350 according to the present invention includes a taller section 352 and a shorter section 354. Flat barbed projections 356, 358 molded as part of the shorter section 354 mate with detents 360, 362, respectively, molded as part of the taller section 352, to secure the shorter section 354 to the taller section 352.

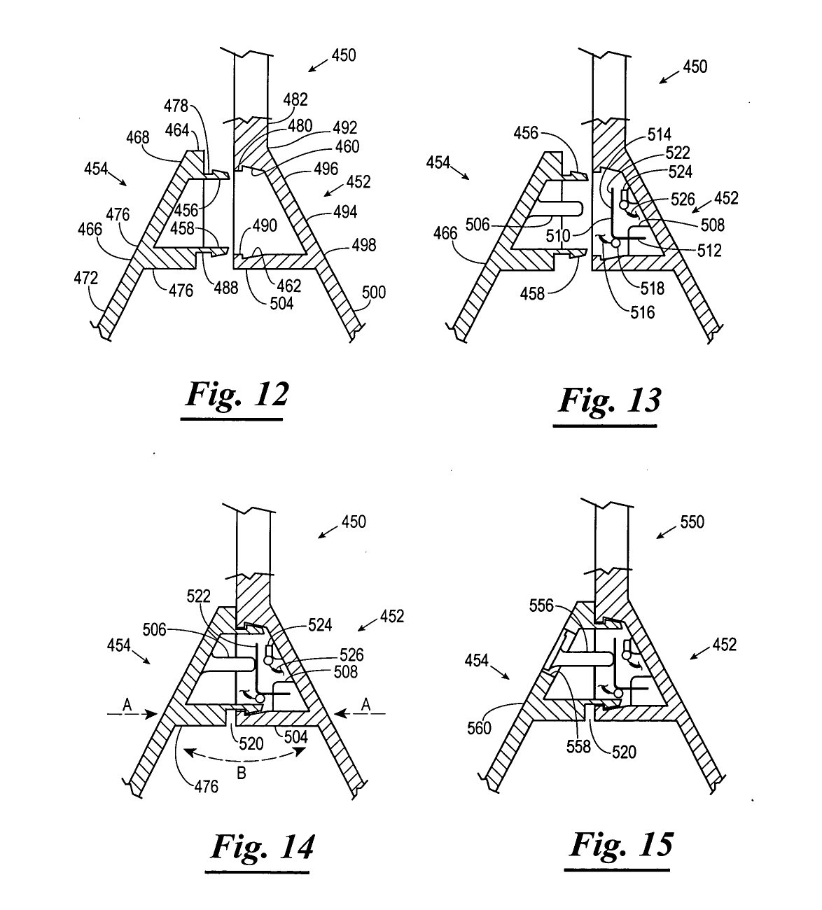

Referring now to FIGS. 12-13, another table topper 450 according to the present invention includes a taller section 452 and a shorter section 454.

Referring now to FIG. 12, a flat barbed projection 456 molded as a part of the shorter section 454 mates with a detent 460 molded as a part of the taller section 452. An extended flat barbed projection 458 molded as a part of the shorter section 454 mates with a detent 462 molded as a part of the taller section 452. The shorter section 454 includes a top ridge 464, a leg member 466 having an upper portion 468, an intermediate portion 470, and a lower portion, 472, and a lower edge 474 (not shown; see 166 and 168 in FIGS. 6-8). A horizontal member 476 located adjacent the intermediate portion 470 of the shorter section leg member 466 terminates in the extended flat barbed projection 458. The flat barbed projection 456 projects horizontally from the shorter section leg member 466 adjacent the upper portion 468 of the shorter section leg member 466 just below the top ridge 464.

Still referring to FIG. 12, the flat barbed projection 456 includes a recess 478. The mating detent 460 includes a shoulder 480. When the shorter section 454 and the taller section 452 are assembled, the recess 478 snugly receives the shoulder 480 of the mating detent 460.

Still referring to FIG. 12, the extended flat barbed projection 458 includes an elongated recess 488. The mating detent 462 has a shoulder 490. When the shorter section 454 and the taller section are assembled, the elongated recess 488 loosely receives the shoulder 490 of the mating detent 462.

Still referring to FIG. 12, the taller section 452 includes a junction region 492, a leg member 494 having an upper portion 496, an intermediate portion 498, and a lower portion 500, and a lower edge 502 (not shown). A horizontal member 504 located adjacent the intermediate portion 498 of the taller section leg member 494 terminates in the detent 462 to receive the extended flat barbed projection 458. The detent 460 is located adjacent the upper portion 496 of the taller section leg member 494 to receive the flat barbed projection 456. The junction region 492 refers to the junction of the taller section leg member 494 with the upper portion 482 of the taller section 452.

Referring now to FIGS. 13-14, a switch actuator 506 projects horizontally from the shorter section leg member 466 between the flat barbed projection 456 and the extended flat barbed projection 458 in the shorter section 454. An anchor block 508 molded into the taller section 452 supports an L-shaped conductive spring 510 having a short side 512 and a long side 514. An electrical lead 516 terminates at a terminal 518 in contact with the short side 512 of the L-shaped conductive spring 510. The long side 514 of the L-shaped conductive spring 510 is aligned with the switch actuator 506 when the taller section 452 is secured to the shorter section 454 as shown in FIG. 14 so that a gap 520 is created between portions of the mating extended flat barbed projection 458 and the mating detent 460. The free end 522 of the long side 514 of the L-shaped conductive spring 510 is aligned with a second terminal contact 524 attached to a second electrical lead 526.

Referring now to FIG. 14, as force is applied along A, the shorter section leg member 466 and the taller section leg member 494 move toward each other along B. The switch actuator 506 then contacts the second terminal contact 524 to close the electrical circuit and energize the lamp 200 (see FIGS. 6-8). As the force applied along A is removed, the L-shaped conductive spring 510 causes the shorter section leg member 466 and the taller section leg member 494 to move away from each other along B (and thereby opening the switched circuit).

Referring now to FIG. 15, another table topper 550 according to applicant's invention includes a taller section 452 and a shorter section 554. A removable switch actuator 556 is cemented in place within a cavity 558 in the leg member 560 of the shorter section 554. Otherwise, the table topper 550 show in FIG. 15 operates like the table topper 450 shown in FIGS. 12-14.

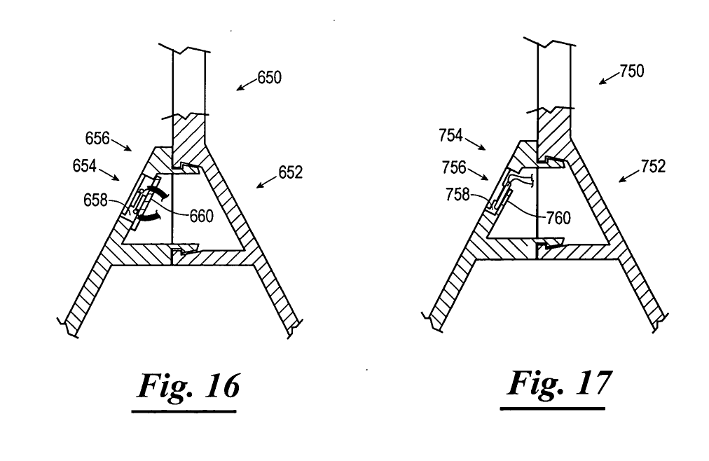

Referring now to FIG. 16, another table topper 650 according to applicant's invention includes a taller section 652 and a shorter section 654. A touch switch 656 is deployed in a cavity 658 in the shorter section 654 and held in place by a backing plate 660.

Referring now to FIG. 17, another table topper 750 according to applicant's invention includes a taller section 752 and a shorter section 754. A touch switch 756 is deployed in a cavity 758 in the shorter section 754 and held in place by a tab 760 integrally molded as part of the shorter section 754.

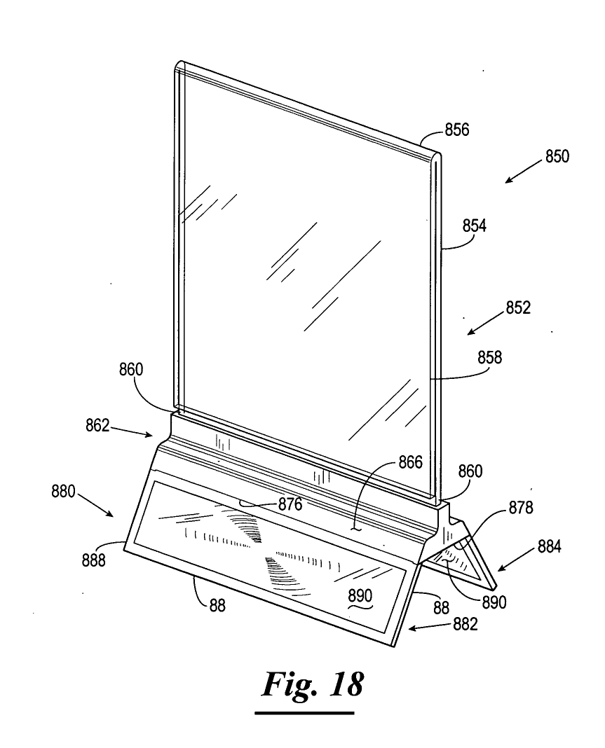

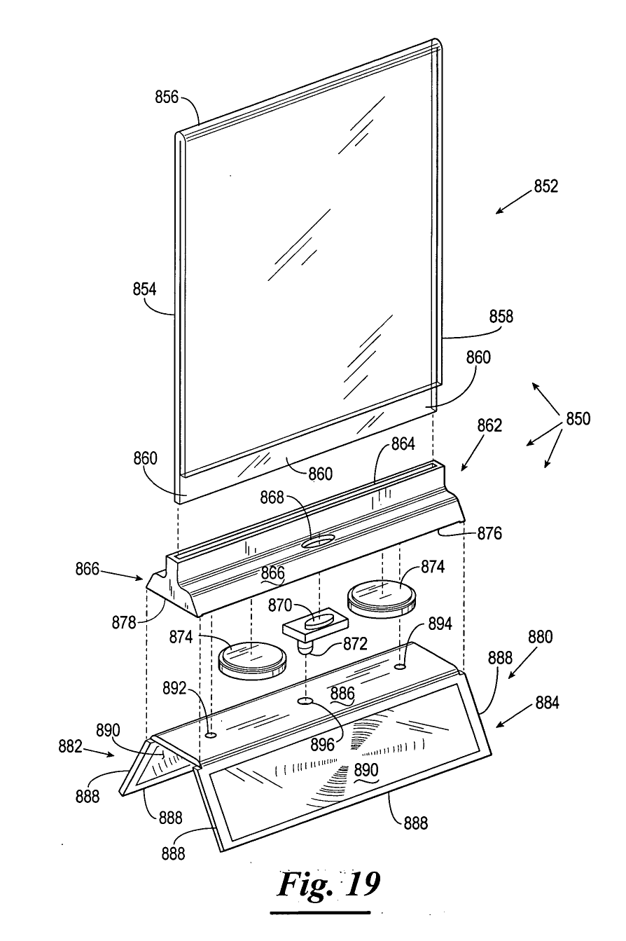

Referring now to FIGS. 18-19, another table topper 850 according to applicant's invention includes a vertical foldover transparent display panel 852 having a longer section 854, a u-shaped fold 856, and a shorter section 858. The longer section 854 has a lower portion 860.

Still referring to FIGS. 18-19, a junction member 862 includes an integrally molded vertical slot 864 upstanding from a downwardly flared portion 866. The vertically upstanding slot 864 receives the lower portion 860 of the longer section 854 of the vertical foldover display panel 852. An aperture 868 in the downwardly flared portion 866 receives a switch 870 connected in series with a lamp 872 and batteries 874. The downwardly flared portion 866 terminates in parallel sided edges 876 and parallel end edges 878.

Still referring to FIGS. 18-19, a base 880 has two leg members 882, 884 connected by a horizontal rectangular section 886. Each leg member 882, 884 includes a frame 888 and a molded fresnel lens 890. The horizontal rectangular section 886 has apertures 892, 894 for routing electrical connectors and a lamp aperture 896. When the table topper 850 is assembled as shown in FIG. 18, the lamp 872 protrudes though the lamp aperture 896 to light the check or sales slip placed in the area between the leg members 882, 884 for viewing through at least one of the fresnel lenses 890.

Still referring to FIGS. 18-19, the horizontal rectangular section 886 terminates in parallel sided edges 898 and parallel end edges 900. As shown more clearly in FIG. 19, the parallel side edges 898 of the horizontal rectangular section 886 engage the parallel side edges 876 of the flared portion 866 of the junction member 862. Likewise, the parallel end edges 900 of the horizontal rectangular section 886 engage the parallel end edges 878 of the flared portion 866 of the junction member 862.

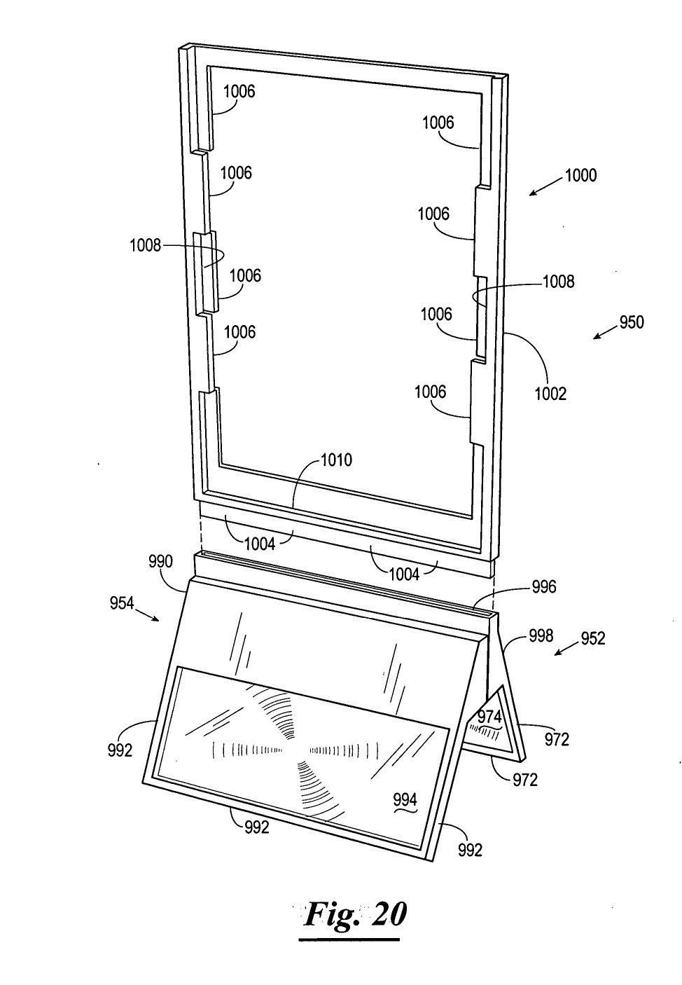

Referring now to FIG. 20, another table topper 950 according to applicant's invention is shown. A first leg member 952 mates with a second leg member 954 (see FIGS. 1-15 for mating details) to form a base. The first leg member 952 includes a frame 972 and a fresnel lens 974 within the frame 972. The second leg member 954 includes a frame 992 and another fresnel lens 994 within the frame 992.

Still referring to FIG. 20, the first leg member includes an integrally molded vertical slot 996 upstanding from a top portion 998 of the first leg member 952. A vertical display member 1000 includes an upper frame portion 1002 for holding advertising or informational material (not shown) and a tongue 1004. When assembled for use, the tongue 1004 is inserted in the vertical slot 996 and secured by frictional bias between the tongue 1004 and the structure forming the vertical slot 996. Staggered opposing tabs 1006 in the upper frame portion 1002 of the vertical display member 1000 cooperate to form a pair of vertically aligned elongated slots 1008. The vertically aligned elongated slots 1008 are adapted to receive advertising or other informational material to be displayed in the table topper 950. A bottom rail 1010, essentially co-planar with the vertically aligned elongated slots 1008, supports the advertising or other material.

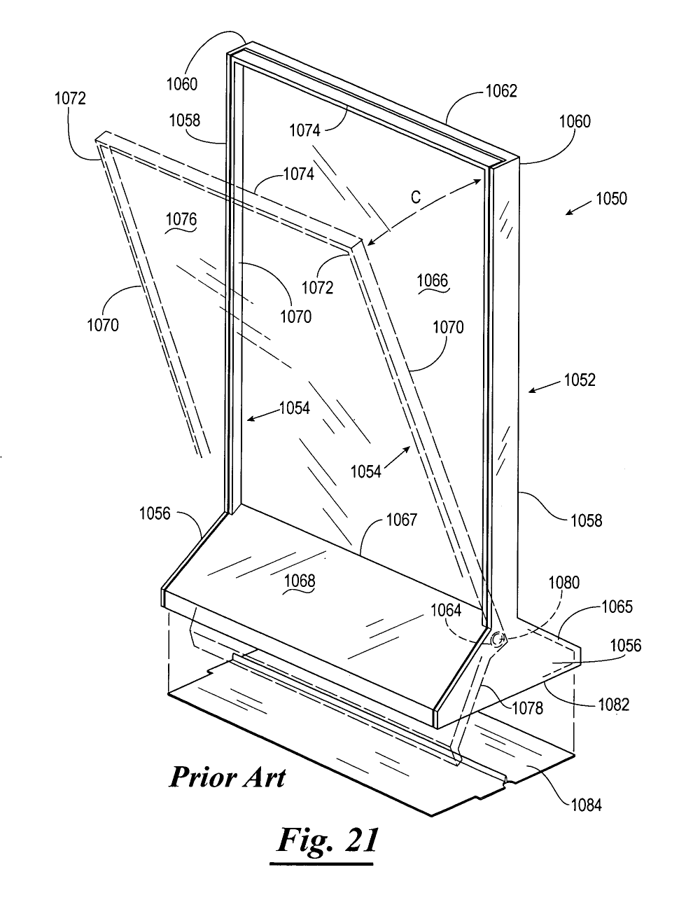

Referring now to FIG. 21, a prior art table topper 1050 is formed by a first molded member 1052 and an inner-fitting second molded member 1054. The first molded member 1052 includes two triangular foot portions 1056, upwardly extending sides 1058 having upper end portions 1060, and an integrally molded top horizontal member 1062 connecting the upper end portions 1060 of the upwardly extend sides 1058. The integrally molded top horizontal member 1062 extends across only a portion of the upper end portions 1060 of the upwardly extending sides 1058. Each triangular foot portion 1056 includes an inner detente 1064 (only one shown). The upwardly extending sides 1058 and the top horizontal member 1062 cooperate to support an integrally molded transparent pane 1066. An integrally molded transverse section 1065 extends between edges 1067 of the triangular foot portions 1056.

Still referring to FIG. 21, the inner-fitting second molded member 1054 includes a transverse foot member 1068, upwardly extending sides 1070 having upper end portions 1072, and an integrally molded top horizontal member 1074 connecting the upper end portions 1072 of the upwardly extending sides 1070. The upwardly extending sides 1070, the transverse foot member 1068, and the top horizontal member 1074 cooperate to support an integrally molded transparent pane 1076. The transverse foot member 1068 has end faces 1078 (only one shown). Bosses 1080 (one on each end face 1078) mate with the inner detents 1064 of the triangular foot portions 1056 of the first molded member 1052.

Still referring to FIG. 21, the second molded member 1054 nests within the first molded member 1052 and pivots on the bosses 1080 received by the inner detents 1064. From a closed position, shown in solid lines in FIG. 21, the transparent pane 1076 of the second molded member 1054 moves away from the transparent pane 1066 of the first molded member 1052 to an open position, wherein the second molded member 1054 is shown in phantom. The upper end portions 1072 of the upwardly extending sides 1070 of the second molded member 1054 move away from the upper end portions 1060 of the upwardly extending sides 1058 of the first molded member 1052 along C to receive advertising and other information between transparent panes 1066, 1076. In the closed position, the top horizontal member 1074 of the second molded member 1054 rests against the top horizontal member 1062 of the first molded member 1052.

Still referring to FIG. 21, in the closed position, the triangular foot portions 1056 of the first molded member 1052, the integrally molded transverse section 1067 of the first molded member 1052, and the transverse foot member 1068 of the second molded member 1054 cooperate to form a cavity 1082. A slightly flexible plastic card 1084 is removably inserted into the cavity 1082 to force the molded transverse section 1067 of the first molded member 1052 away from the transverse foot member 1068 of the second molded member 1054, thereby preventing the second molded member 1054 from pivoting within the first molded member 1052 and, consequently, maintaining the table topper 1050 in the closed position. The slightly flexible plastic card 1084 is sized so that some flexing is required to insert plastic card 1084 into the cavity 1082. Until removed, the slightly flexible plastic card 1084 is maintained within the cavity 1082 by frictional bias.

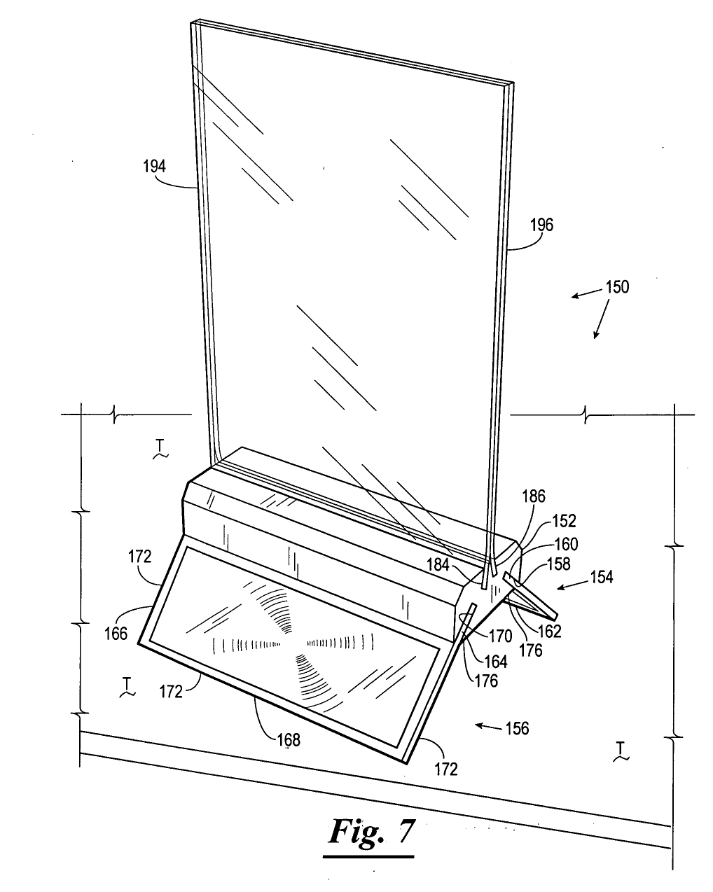

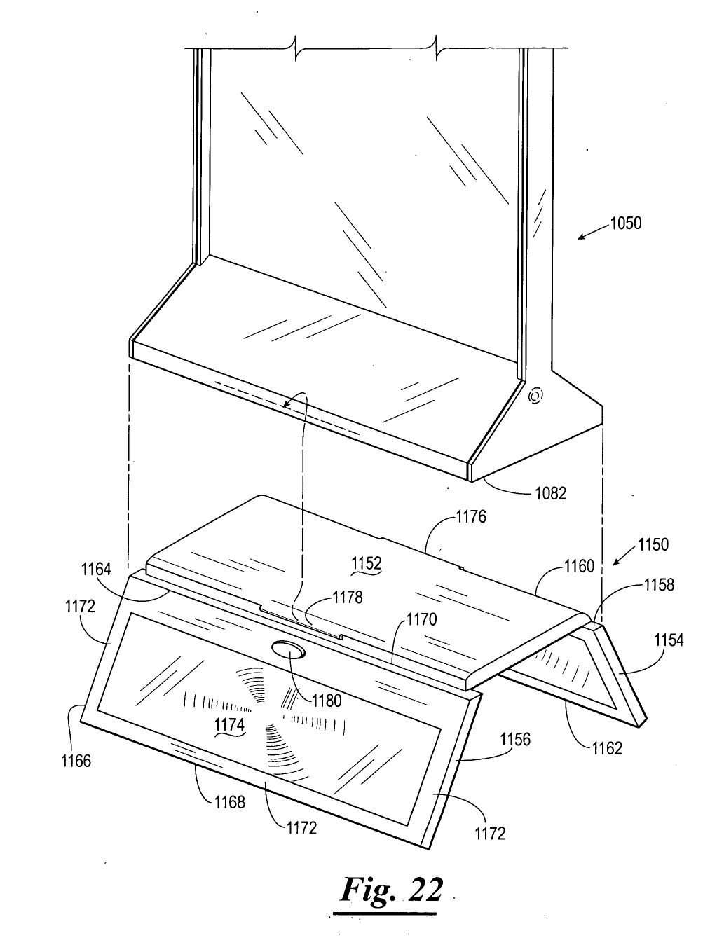

Referring now to FIG. 22, applicant's illuminated magnifier base 1150 is adapted for attachment to the prior art table topper 1050 shown in FIG. 21 to create a table topper with illuminated magnifier. The illuminated magnifier base 1150 according to applicant's invention includes a generally rectangular plate 1152 supported by leg member 1154 and magnifying leg member 1156. The upper portion 1158 of the leg member 1154 is attached to a long edge 1160 of the rectangular plate 1152, and the lower edge 1162 of the leg member 1154 rests on the table top (See FIGS. 6-7). The magnifying leg member 1156 has an upper portion 1164, a lower portion 1166, and a lower edge 1168. The upper portion 1164 of the magnifying leg member 1156 is attached to the other long edge 1170 of the rectangular plate 1152, and the lower edge 1168 of the magnifying leg member 1156 rests on the table top (See FIGS. 6-7). The lower portion 1166 of the magnifying leg member 1156 includes a frame portion 1172. A molded fresnel lens 1174 is attached to the frame portion 1172 of the magnifying leg member 1156.

Still referring to FIG. 22, rectangular plate 1152 supports tabs 1176, 1178 along the long edges 1160, 1170. The rectangular plate 1152 is received within the cavity 1082 of the prior art table topper 1050 and held in place by the tabs 1176, 1178. A switch 1180 actuates a lamp powered by a battery (See FIG. 8) located beneath the rectangular plate 1152. It will be understood by one skilled in the art that the rectangular plate 1152 replaces the slightly flexible plastic card 1084 in the prior art table topper 1050.

Referring now to FIG. 23, another illuminated magnifier base 1250 according to applicant's invention is adapted for attachment to the prior art table topper 1050 shown in FIG. 21 to create a table topper with illuminated magnifier. The illuminated magnifier base 1250 according to applicant's invention includes a rectangular plate 1252 supported by leg member 1254 and magnifying leg member 1256. The upper portion 1258 of the leg member 1254 is attached to a long edge 1260 of the rectangular plate 1252, and the lower edge 1262 of the leg member 1254 rests on the table top (See FIGS. 6-7). The magnifying leg member 1256 has an upper portion 1264, a lower portion 1266, and a lower edge 1268. The upper portion 1264 of the magnifying leg member 1256 is attached to the other long edge 1270 of the rectangular plate 1252, and the lower edge 1268 of the magnifying leg member 1256 rests on the table top (See FIGS. 6-7). The lower portion 1266 of the magnifying leg member 1256 includes a frame portion 1272. A molded fresnel lens 1274 is attached to the frame portion 1272 of the magnifying leg member 1256.

Still referring to FIG. 23, lipped rails 1276, 1278 along the long edges 1260, 1270 of the rectangular plate 1252 receive the base portion 1086 of the prior art table topper 1050. Each lipped rail 1276, 1278 extends upwardly from the rectangular plate 1252 and terminates in an inwardly directed lip 1280, 1282 respectively. The base portion 1086 of the prior art table topper 1050 is slidably received between the lipped rails 1276, 1278 of applicant's illuminated magnifier base 1250. A switch 1284 actuates a lamp powered by a battery (See FIG. 8) located beneath the rectangular plate 1252. It will be understood by one skilled in the art that the rectangular plate 1252 receives the intact prior art table topper 1050. The removable slightly flexible plastic card 1084 in the prior art table topper 1050 remains in place to maintain the prior art table topper 1050 in a closed position. To insert advertising or other information between the transparent panes 1066, 1076, the prior art table topper 1050 is first removed from the illuminated magnifier base 1250 and then the flexible plastic card 1084 is removed from the base portion 1086 of the prior art table topper 1050.

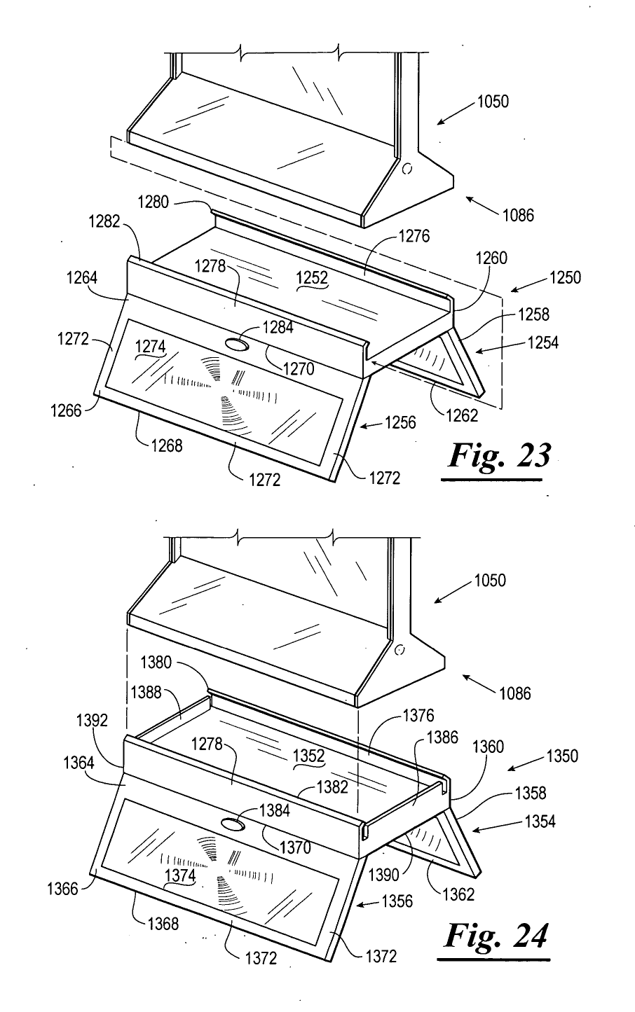

Referring now to FIG. 24, another illuminated magnifier base 1350 according to applicant's invention is adapted for attachment to the prior art table topper 1050 shown in FIG. 21 to create a table topper with illuminated magnifier. The illuminated magnifier base 1350 according to applicant's invention includes a rectangular plate 1352 supported by leg member 1354 and magnifying leg member 1356. The upper portion 1358 of the leg member 1354 is attached to a long edge 1360 of the rectangular plate 1352, and the lower edge 1362 of the leg member 1354 rests on the table top (See FIGS. 6-7). The magnifying leg member 1356 has an upper portion 1364, a lower portion 1366, and a lower edge 1368. The upper portion 1364 of the magnifying leg member 1356 is attached to the other long edge 1370 of the rectangular plate 1352, and the lower edge 1368 of the magnifying leg member 1356 rests on the table top (See FIGS. 6-7). The lower portion 1366 of the magnifying leg member 1356 includes a frame portion 1372. A molded fresnel lens 1374 is attached to the frame portion 1372 of the magnifying leg member 1356.

Still referring to FIG. 24, integrally molded flexible lipped rails 1376, 1378 along the long edges 1360, 1370 of the rectangular plate 1352, together with straight rails 1386, 1388 along the short edges 1390, 1392 of the rectangular plate 1352, receive the base portion 1086 of the prior art table topper 1050. Each lipped rail 1376, 1378 extends upwardly from the rectangular plate 1352 and terminates in an inwardly directed lip 1380, 1382 respectively. The base portion 1086 of the prior art table topper 1050 is received between the lipped rails 1376, 1378 and the straight rails 1386, 1388 of applicant's illuminated magnifier base 1350. A switch 1384 actuates a lamp powered by a battery (See FIG. 8) located beneath the rectangular plate 1352. It will be understood by one skilled in the art that the rectangular plate 1352 receives the intact prior art table topper 1050. The removable flexible plastic card 1084 in the prior art table topper 1050 remains in place to maintain the prior art table topper 1050 in a closed position. To insert advertising or other information between the transparent panes 1066, 1076, the prior art table topper 1050 is first removed from the illuminated magnifier base 1350 and then the flexible plastic card 1084 is removed from the base portion 1086 of the prior art table topper 1050.

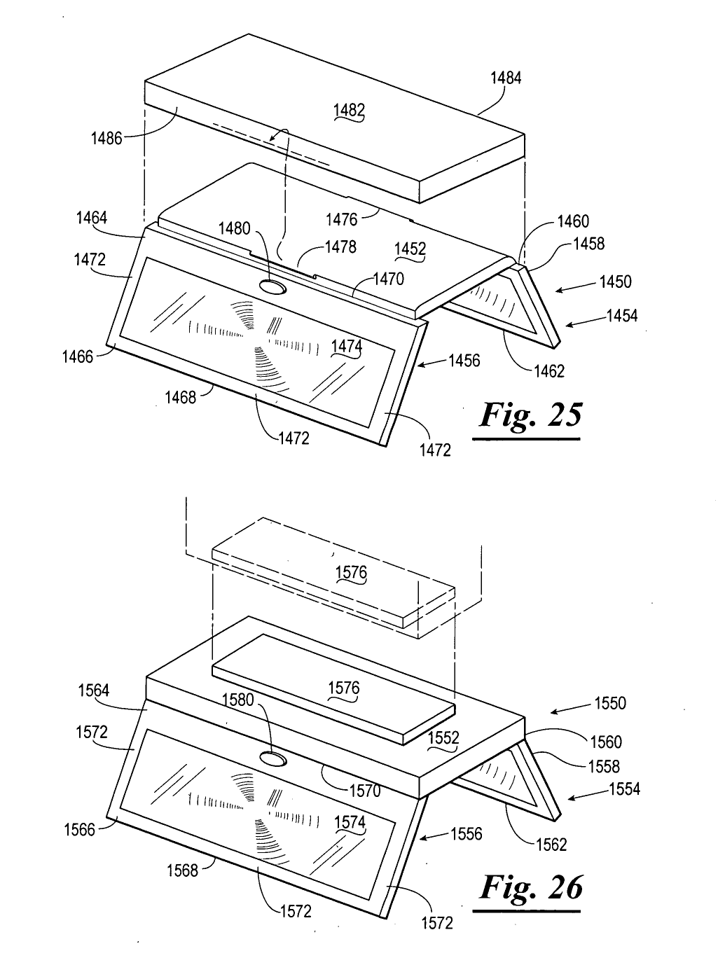

Referring now to FIG. 25, another illuminated magnifier base 1450 according to applicant's invention is adapted for use as a stand-alone support for the prior art table topper 1050 shown in FIG. 21, for an ash tray, for a check tray, or for other devices as appropriate. The illuminated magnifier base 1450 according to applicant's invention includes a rectangular plate 1452 supported by leg member 1454 and magnifying leg member 1456. The upper portion 1458 of the leg member 1454 is attached to a long edge 1460 of the rectangular plate 1452, and the lower edge 1462 of the leg member 1454 rests on the table top (See FIGS. 6-7). The magnifying leg member 1456 has an upper portion 1464, a lower portion 1466, and a lower edge 1468. The upper portion 1464 of the magnifying leg member 1456 is attached to the other long edge 1470 of the rectangular plate 1452, and the lower edge 1468 of the magnifying leg member 1456 rests on the table top (See FIGS. 6-7). The lower portion 1466 of the magnifying leg member 1456 includes a frame portion 1472. A molded fresnel lens 1474 is attached to the frame portion 1472 of the magnifying leg member 1456.

Still referring to FIG. 25, rectangular plate 1452 includes tabs 1476, 1478 along the long edges 1460, 1470. A cap 1482 is placed over the rectangular plate 1452 so that sides 1474, 1476 of the cap 1482 are frictionally biased against the sides 1484, 1486 of the cap 1482. A switch 1480 actuates a lamp powered by a battery (See FIG. 8) located beneath the rectangular plate 1452. It will be understood by one skilled in the art that the cap 1472 provides a smooth surface to support another device. It will also be understood by one skilled in the art that the cap 1482 can be incorporated into the structure of other devices so the devices can be easily attached to and removed from applicant's illuminated magnifier base.

Referring now to FIG. 26, another illuminated magnifier base 1550 according to applicant's invention is adapted for attachment to another device such as an ash tray, for a check tray, or for other devices as appropriate. The illuminated magnifier base 1550 includes a rectangular plate 1552 supported by leg member 1554 and magnifying leg member 1556. The upper portion 1558 of the leg member 1554 is attached to a long edge 1560 of the rectangular plate 1552, and the lower edge 1562 of the leg member 1554 rests on the table top (See FIGS. 6-7). The magnifying leg member 1556 has an upper portion 1564, a lower portion 1566, and a lower edge 1568. The upper portion 1564 of the magnifying leg member 1556 is attached to the other long edge 1570 of the rectangular plate 1552, and the lower edge 1568 of the magnifying leg member 1556 rests on the table top (See FIGS. 6-7). The lower portion 1566 of the magnifying leg member 1556 includes a frame portion 1572. A molded fresnel lens 1574 is attached to the frame portion 1572 of the magnifying leg member 1556.

Still referring to FIG. 26, double-sided tape 1576 secures applicant's illuminated magnifier base 1550 to a prior art table topper or other device. It will be understood by one skilled in the art that the double-sided tape can be incorporated into the structure of other devices so the devices can be easily attached to and removed from applicant's illuminated magnifier base 1550. A switch 1580 actuates a lamp powered by a battery (See FIG. 8) located beneath the rectangular plate 1552.

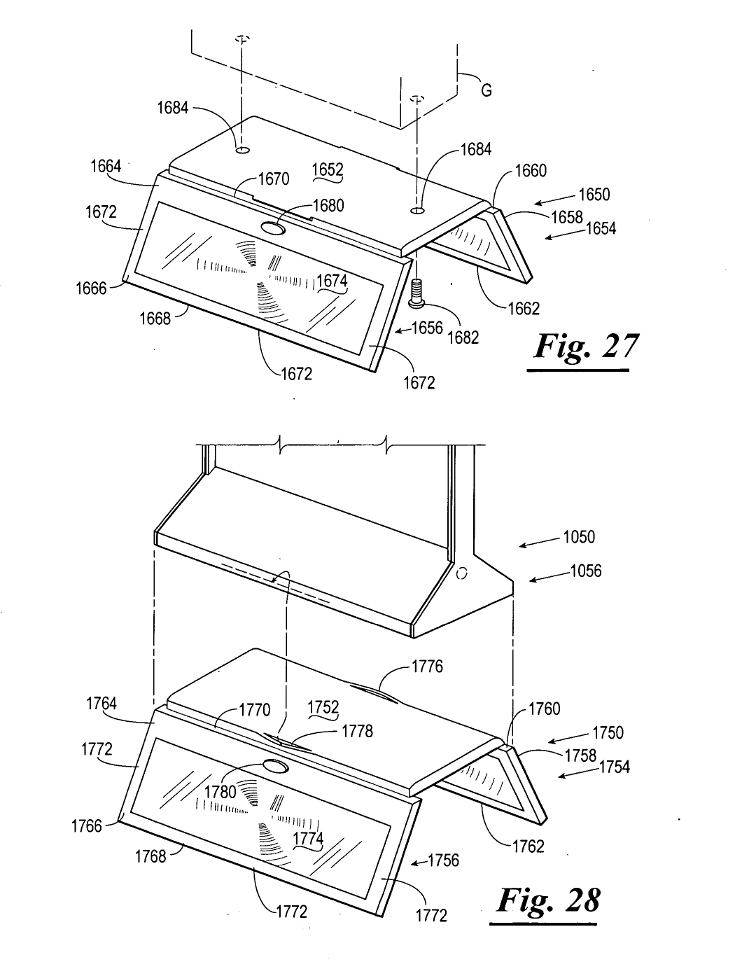

Referring now to FIG. 27, another illuminated magnifier base 1650 according to applicant's invention is adapted for attachment to another device such as an ash tray, for a check tray, or for other devices as appropriate. The illuminated magnifier base 1650 includes a rectangular plate 1652 supported by leg member 1654 and magnifying leg member 1656. The upper portion 1658 of the leg member 1654 is attached to a long edge 1660 of the rectangular plate 1652, and the lower edge 1662 of the leg member 1654 rests on the table top (See FIGS. 6-7). The magnifying leg member 1656 has an upper portion 1664, a lower portion 1666, and a lower edge 1668. The upper portion 1664 of the magnifying leg member 1656 is attached to the other long edge 1670 of the rectangular plate 1652, and the lower edge 1668 of the magnifying leg member 1656 rests on the table top (See FIGS. 6-7). The lower portion 1666 of the magnifying leg member 1656 includes a frame portion 1672. A molded fresnel lens 1674 is attached to the frame portion 1672 of the magnifying leg member 1656. A switch 1680 actuates a lamp powered by a battery (See FIG. 8) located beneath the rectangular plate 1652.

Still referring to FIG. 27, screws 1682 extend through bores 1684 in the rectangular plate 1652 into a generic device G.

Referring now to FIG. 28, another illuminated magnifier base 1750 according to applicant's invention is adapted for attachment to the prior art table topper 1050 shown in FIG. 21 to create a table topper with illuminated magnifier. The illuminated magnifier base 1750 according to applicant's invention includes a rectangular plate 1752 supported by leg member 1754 and magnifying leg member 1756. The upper portion 1758 of the leg member 1754 is attached to a long edge 1760 of the rectangular plate 1752, and the lower edge 1762 of the leg member 1754 rests on the table top (See FIGS. 6-7). The magnifying leg member 1756 has an upper portion 1764, a lower portion 1766, and a lower edge 1768. The upper portion 1764 of the magnifying leg member 1756 is attached to the other long edge 1770 of the rectangular plate 1752, and the lower edge 1768 of the magnifying leg member 1756 rests on the table top (See FIGS. 6-7). The lower portion 1766 of the magnifying leg member 1756 includes a frame portion 1772. A molded fresnel lens 1774 is attached to the frame portion 1772 of the magnifying leg member 1756.

Still referring to FIG. 28, two bosses 1776, 1778 on the rectangular plate 1752 receives the base portion 1086 of the prior art table topper 1050. Two bosses 1776, 1778 create a frictional bias against the sides of the base portion 1086 to secure the base portion 1086 to the rectangular plate 1752.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. An illuminated magnifier base for supporting a prior art table topper or other device, the illuminated magnifier base comprising:
a rectangular plate having a top, a bottom, two long edges, and two short edges;
a first leg member having an upper portion, a lower portion, and a lower edge, wherein the upper portion of the leg member is attached to one of the long edges of the rectangular plate;
a second leg member having an upper portion, a lower portion, and a lower edge, wherein the upper portion of the second leg member is attached to the other long edge of the rectangular plate;
a magnifying member attached to the one leg member;
a lamp-battery assembly attached to the bottom of the rectangular plate;
a switch attached to a leg member for switching on the battery-powered lamp, wherein the switch is in serial connection with the lamp and the battery; and
attaching means for attaching the illuminated magnifier base to the prior art table topper or other device.

2. The device of claim 1, wherein the rectangular plate fits within a base portion of the prior art table topper.

3. The device of claim 1, wherein the attaching means further comprises:
a first lipped rail attached to one long edge of the rectangular plate, wherein the lipped rail extends upwardly from the long edge of the rectangular plate and terminates in an inwardly directed lip; and
a second lipped rail attached to the other long edge of the rectangular plate, wherein the second lipped rail extends upwardly from the other long edge of the rectangular plate and terminates in an inwardly directed lip;
so that the base portion of the prior art table topper is slidably received between the first and second lipped rails above the rectangular plate.

4. The device of claim 1 wherein said attaching means further comprises:
a first flexible lipped rail attached to one long edge of the rectangular plate, wherein the flexible lipped rail extends upwardly from the long edge of the rectangular plate and terminates in an inwardly directed lip; and
a second flexible lipped rail attached to the other long edge of the rectangular plate, wherein the second flexible lipped rail extends upwardly from the other long edge of the rectangular plate and terminates in an inwardly directed lip;
a first upwardly extending straight rail attached to one short edge of the rectangular plate; and
a second upwardly extending straight rail attached to the other short edge of the rectangular plate;
so that the base portion of the prior art table topper is removably received between the first and second flexible lipped rails and the first and second upwardly extending straight rails above the rectangular plate.

5. A table-top advertising support with illuminated magnifier (also referred to as a table topper), comprising:
an illuminated magnifier base;
an advertising support having a vertical mast portion and a base portion, the base portion having a generally rectangular bottom; and
means for attaching the advertising support to the illuminated magnifier base.

6. The device of claim 5 wherein the means for attaching the vertical mast to the illuminated magnifier base further comprises double-sided tape, wherein the double-sided tape secures the base portion of the advertising support to the illuminated magnifier base.

7. The device of claim 5, wherein the means for attaching the vertical mast to the illuminated magnifier base further comprises screws connecting the base portion of the advertising support to the illuminated magnifier base.

8. An illuminated magnifier base for supporting a table topper or other device, the illuminated magnifier base comprising:
a rectangular plate having a top, a bottom, two long edges, and two short edges;
a first leg member having an upper portion, a lower portion, and a lower edge, wherein the upper portion of the leg member is attached to one of the long edges of the rectangular plate;
a second leg member having an upper portion, a lower portion, and a lower edge, wherein the upper portion of the second leg member is attached to the other long edge of the rectangular plate;
a magnifying member attached to the one leg member;
a lamp-battery assembly attached to the bottom of the rectangular plate; and
a switch attached to a leg member for switching on the battery-powered lamp, wherein the switch is in serial connection with the lamp and the battery.
